(19) United States
(12) Patent Application Publication
(10) Pub. No.: US 2009/0284846 A1
(43) Pub. Date: Nov. 19, 2009

(54) Imaging lens

(75) Inventors: Hiroyuki Teraoka, Suita-shi (JP); Junji Kitamura, Suita-shi (JP)

Correspondence Address: EDWARDS ANGELL PALMER & DODGE LLP, P.O. BOX 55874, BOSTON, MA, 02205, US

(73) Assignee: KOMATSULITE MFG. CO., LTD., Suita-shi (JP)

(21) Appl. No.: 12/453,298

(22) Filed: May 6, 2009

(30) Foreign Application Priority Data
May 14, 2008 (JP) 2008-126805

(51) Int. Cl. G02B 9/16

(52) U.S. Cl. 359/785

(57) ABSTRACT

The present invention provides an imaging lens that includes, in order from an object, a diaphragm S1; a first lens L1 with a positive power and a meniscus shape that is convex toward an object side; a second lens L2 with a negative power and a meniscus shape that is convex toward an image side; and a third lens L3 with a positive power and a meniscus shape that is convex toward the object side; the imaging lens satisfying Conditional Expressions (1) to (3):

0.95<f1/f<1.50 (1);

−0.50<f1/f2<−0.00 (2); and

0.40<d1/d2<0.70 (3);

wherein:
f: a focal length of the entire lens system;
f1: a focal length of the first lens;
f2: a focal length of the second lens;
d1: a center thickness of the first lens; and
d2: a distance between an image-side surface of the first lens and an object-side surface of the second lens.

### BACKGROUND OF THE INVENTION

The present invention relates to imaging lenses. More particularly, the invention relates to an imaging lens having three lenses, which is small and has good optical characteristics, and is suitable for small imaging apparatuses, optical sensors, portable module cameras, Web cameras, and the like, that use solid-state image sensors, such as a high-pixel CCD, CMOS, and the like.

Various types of imaging apparatuses that use a solid-state image sensor such as a CCD, CMOS, and the like, have recently become widespread. As these image sensors have decreased in size and improved in performance, demands have also been made for the imaging lenses that are used in the imaging apparatuses to achieve smaller sizes and good optical characteristics.

In an attempt to reduce the size and weight of the imaging lens, lens systems of a one-lens configuration or two-lens configuration have been suggested. However, although these lens systems are advantageous in terms of smaller size and lighter weight, they fail to exhibit sufficient improvements in the performance that is demanded in imaging lenses, such as high image quality, high resolution, etc.

For this reason, technical development is proceeding for an imaging lens that can achieve high image quality and high resolution by using a three-lens configuration, and imaging lenses with various configurations have been proposed. For example, imaging lenses have been disclosed that include, in order from an object, a diaphragm; a first lens with a positive power and a meniscus shape that is convex toward an object side; a second lens with a negative power and a meniscus shape that is convex toward an image side; and a third lens with a meniscus shape that is convex toward the object side.

For example, the imaging lens disclosed in Japanese Pat. No. 4,041,521 includes, in order from an object side, a diaphragm, a first lens with a positive meniscus shape that is convex toward the object side; a second lens with a negative meniscus shape that is convex toward an image side; and a third lens with a positive meniscus shape that is convex toward the object side. The size of this imaging lens has been reduced by increasing the positive power of the first lens. Moreover, good correction of on-axis chromatic aberration has been achieved by increasing the negative power of the second lens. However, owing to the strong power of the first and second lenses, variations in the image plane due to positional shifts during manufacture are large, sometimes making it difficult to manufacture the imaging lens.

### DISCLOSURE OF THE INVENTION

The present invention has been accomplished to solve the problem of prior art. An object of the invention is to provide an imaging lens having three lenses, which is small, has good optical characteristics in which various aberrations have been suitably corrected, and is easy to manufacture.

The inventors conducted extensive research to achieve the above-mentioned object. As a result, they found that the desired imaging lens can be obtained by specifying the power of a first lens with respect to the entire imaging lens, the power distribution of the first lens and a second lens, and the relationship between the center thickness of the first lens and the distance between the image-side surface of the first lens and the object-side surface of the second lens. This has led to the completion of the invention.

The invention provides an imaging lens that includes, in order from an object, a diaphragm; a first lens with a positive power and a meniscus shape that is convex toward an object side; a second lens with a negative power and a meniscus shape that is convex toward an image side; and a third lens with a positive power and a meniscus shape that is convex toward the object side; the imaging lens satisfying Conditional Expressions (1) to (3):

0.95<f1/f<1.50 (1);

−0.50<f1/f2<−0.00 (2); and

0.40<d1/d2<0.70 (3);

wherein:

f: a focal length of the entire lens system;

f1: a focal length of the first lens;

f2: a focal length of the second lens;

d1: a center thickness of the first lens; and

d2: a distance between an image-side surface of the first lens and an object-side surface of the second lens.

The imaging lens according to the invention overcomes the problem of prior art, is small in size, and exhibits good optical characteristics. The imaging lens provided according to the invention is used in portable module cameras, Web cameras, personal computers, digital cameras, optical sensors for automobiles and various industrial apparatuses, monitors, and the like, thereby contributing to the smaller size and improved performance of these apparatuses.

### BRIEF DESCRIPTION OF THE DRAWINGS

FIG. 1 is a schematic diagram showing the configuration of one embodiment of the imaging lens of the invention;

FIG. 2 is a schematic diagram showing the configuration of the imaging lens of Example 1 of the invention;

FIG. 3 is a diagram showing the spherical aberration of the imaging lens of Example 1;

FIGS. 4(A) and 4(B) are diagrams respectively showing the astigmatism and distortion aberration of the imaging lens of Example 1;

FIG. 5 is a diagram showing the magnification chromatic aberration of the imaging lens of Example 1;

FIG. 6 is a schematic diagram showing the configuration of the imaging lens of Example 2 of the invention;

FIG. 7 is a diagram showing the spherical aberration of the imaging lens of Example 2;

FIGS. 8(A) and 8(B) are diagrams respectively showing the astigmatism and distortion aberration of the imaging lens of Example 2;

FIG. 9 is a diagram showing the magnification chromatic aberration of the imaging lens of Example 2;

FIG. 10 is a schematic diagram showing the configuration of the imaging lens of Example 3 of the invention;

FIG. 11 is a diagram showing the spherical aberration of the imaging lens of Example 3;

FIGS. 12(A) and 12(B) are diagrams respectively showing the astigmatism and distortion aberration of the imaging lens of Example 3;

FIG. 13 is a diagram showing the magnification chromatic aberration of the imaging lens of Example 3;

FIG. 14 is a schematic diagram showing the configuration of the imaging lens of Example 4 of the invention;

FIG. 15 is a diagram showing the spherical aberration of the imaging lens of Example 4;

FIGS. 16(A) and 16(B) are diagrams respectively showing the astigmatism and distortion aberration of the imaging lens of Example 4; and

FIG. 17 is a diagram showing the magnification chromatic aberration of the imaging lens of Example 4.

### EXPLANATION OF SYMBOLS

LA: imaging lens
S1: diaphragm
L1: first lens
L2: second lens
L3: third lens
GF: parallel glass plate
R1: radius of curvature of the object-side surface of the first lens L1
R2: radius of curvature of the image-side surface of the first lens L1
R3: radius of curvature of the object-side surface of the second lens L2
R4: radius of curvature of the image-side surface of the second lens L2
R5: radius of curvature of the object-side surface of the third lens L3
R6: radius of curvature of the image-side surface of the third lens L3
R7: radius of curvature of the object-side surface of the parallel glass plate GF
R8: radius of curvature of the image-side surface of the parallel glass plate GF
d1: center thickness of the first lens L1
d2: distance between the image-side surface of the first lens L1 and the object-side surface of the second lens L2
d3: center thickness of the second lens L2
d4: distance between the image-side surface of the second lens L2 and the object-side surface of the third lens L3
d5: center thickness of the third lens L3
d6: distance between the image-side surface of the third lens L3 and the object-side surface of the parallel glass plate GF
d7: center thickness of the parallel glass plate GF

### BEST MODE FOR CARRYING OUT THE INVENTION

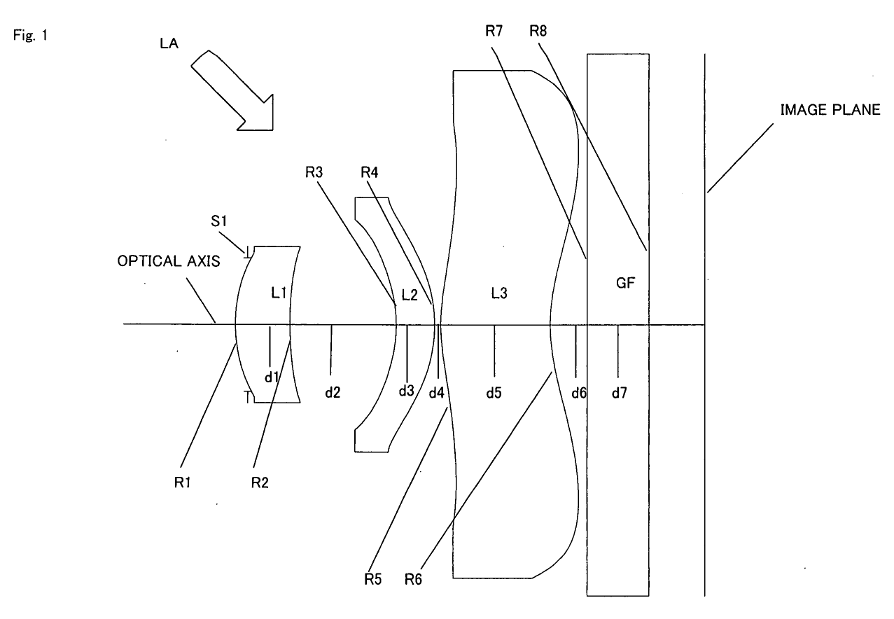

Embodiments of the imaging lens LA according to the invention are described with reference to the drawings. FIG. 1 shows the configuration of an imaging lens according to an embodiment of the invention. The imaging lens LA is a lens system of a three-lens configuration that includes, from an object (not shown) side toward an image plane, a diaphragm S1, a first lens L1, a second lens L2, and a third lens L3. A parallel glass plate GF is disposed between the third lens L3 and the image plane. Examples of usable parallel glass plates GF include those that function as a cover glass, an IR cut filter, a low-pass filter, and the like.

By inserting the diaphragm S1 closer to the object than the first lens L1, it is possible to set the entrance pupil at a position that is distant from the image plane. This makes it easy to ensure high telecentricity and enables a preferable angle of incidence relative to the image plane.

The first lens L1 is a lens with a positive power and a meniscus shape that is convex toward the object side. The second lens L2 is a lens with a negative power and a meniscus shape that is convex toward the image side. The third lens L3 is a lens with a positive power and a meniscus shape that is convex toward the object side. For a more preferable correction of various aberrations, preferably at least one surface, and more preferably both surfaces, of the two surfaces that form each lens, are aspheric.

In this embodiment, the diaphragm, the first lens L1 with a positive power and a meniscus shape that is convex toward the object side; the second lens L2 with a negative power and a meniscus shape that is convex toward the image side; and the third lens L3 with a positive power and a meniscus shape that is convex toward the object side, are disposed in order from the object. An imaging lens that is compact, has good optical characteristics, and excellent manufacturability can be obtained by satisfying Conditional Expressions (1) to (3):

0.95<f1/f<1.50 (1)

−0.50<f1/f2<−0.00 (2)

0.40<d1/d2<0.70 (3)

0.45<d1/d2<0.70 (3-a)

To prevent the power of the first lens L1 and the second lens L2 from becoming excessive, both of these lenses preferably have a meniscus shape.

Conditional Expression (1) defines the positive power of the first lens L1. If f1/f falls below the lower limit, the power of the first lens L1 will strengthen and the error sensitivity of the first lens L1 will increase. Conversely, if f1/f exceeds the upper value, it will become difficult to reduce the size of the imaging lens LA, which is undesirable.

Conditional Expression (2) defines the power distribution of the first lens L1 and the second lens L2. If f1/f2 falls below the lower limit, the on-axis chromatic aberration correction will be good, but the manufacture of the second lens L2 may become difficult. Conversely, if 1/f2 exceeds the upper limit, the manufacture of the second lens will become easy, but the on-axis chromatic aberration correction will become difficult, which is undesirable.

Conditional Expression (3) defines the ratio of the center thickness of the first lens L1 relative to the distance between the image-side surface of the first lens L1 and the object-side surface of the second lens L2. Moreover, d1/d2 is preferably within the range of Conditional Expression (3-a). Outside the range of Conditional Expression (3) or (3-a), the correction of off-axis chromatic aberration may become difficult. The manufacture of the first lens L1 may also become difficult, which is undesirable.

The three first to third lenses that constitute the imaging lens LA of the invention can be formed of a glass or a resin material. When glass is used as a lens material, a glass material with a glass transition temperature of 400° C. or less is preferably used. This makes it possible to improve mold durability.

A resin material is preferred to a glass material in terms of productivity, because the use of a resin material enables efficient manufacture of lenses with a complicated surface shape. Therefore, the three lenses that constitute the imaging lens LA of the invention are preferably formed of a resin material. When resin is used as a lens material, it may be a thermoplastic resin or a thermosetting resin, as long as the resin material satisfies the following conditions:
(1) the d line measured according to ASTM D542 has a refractive index ranging from 1.45 to 1.65; and
(2) the light transmittance at wavelengths ranging from 450 to 600 nm is 80% or more, and preferably 85% or more.

Specific examples of resin materials include amorphous polyolefin resins with cyclic structures or other ring structures, polystyrene resins, acrylic resins, polycarbonate resins, polyester resins, epoxy resins, silicone resins, and the like. Among the above, polyolefins containing cycloolefins, polyolefins containing cyclic olefins, polycarbonate resins, and the like are preferably used. With a resin material, the lens is manufactured using a known molding process, such as injection molding, compression molding, casting, transfer molding, and the like.

It is well known that resin materials vary in refractive index and dimensions according to changes in temperature. In order to reduce these variations, the above-mentioned transparent lens materials that contain a dispersion of fine particles of a silica, niobium oxide, titanium oxide, aluminum oxide, or the like, having a mean particle size of 100 nm or less, and more preferably 50 nm or less, are usable as lens materials.

When the lens is manufactured using a resin material, a flange can be provided around the outer periphery of each of the three lenses that constitute the imaging lens LA. The flange may have any shape as long as it does not impair the lens performance. In consideration of lens moldability, the thickness of the flange is preferably from 70 to 130% relative to the thickness of the outer periphery of the lens. When a flange is provided around the outer periphery of the lens, the incidence of light into the flange may cause ghosts or flaring. In such a case, a mask for limiting incident light may be provided between lenses, as required.

Prior to applications in imaging modules and the like, each of the three lenses that constitute the imaging lens LA of the invention may undergo a known surface treatment, such as application of an anti-reflection film, application of an IR block film, surface hardening, or the like, on the object-side surface and/or the image-side surface thereof. Imaging modules using the imaging lens LA are used in portable module cameras, Web cameras, personal computers, digital cameras, optical sensors for automobiles and various industrial apparatuses, monitors, and the like.

### EXAMPLES

Specific examples of the imaging lens LA of the invention are described below. Symbols used in each of the Examples denote the following. The unit of distance is mm.
f: focal length of the entire imaging lens LA
f1: focal length of the first lens L1
f2: focal length of the second lens L2
f3: focal length of the third lens L3
Fno: F number
S1: diaphragm
R: radius of curvature of the optical surface; the central radius of curvature of a lens
R1: radius of curvature of the object-side surface of the first lens L1
R2: radius of curvature of the image-side surface of the first lens L1
R3: radius of curvature of the object-side surface of the second lens L2
R4: radius of curvature of the image-side surface of the second lens L2
R5: radius of curvature of the object-side surface of the third lens L3
R6: radius of curvature of the image-side surface of the third lens L3
R7: radius of curvature of the object-side surface of the parallel glass plate GF
R8: radius of curvature of the image-side surface of the parallel glass plate GF
d: lens thickness or distance between lenses
d1: center thickness of the first lens L1
d2: distance between the image-side surface of the first lens L1 and the object-side surface of the second lens L2
d3: center thickness of the second lens L2
d4: distance between the image-side surface of the second lens L2 and the object-side surface of the third lens L3
d5: center thickness of the third lens L3
d6: distance between the image-side surface of the third lens L3 and the object-side surface of the parallel glass plate GF
d7: center thickness of the parallel glass plate GF
nd: refractive index of d line
n1: refractive index of the first lens L1
n2: refractive index of the second lens L2
n3: refractive index of the third lens L3
n4: refractive index of the parallel glass plate GF
νd: Abbe number at d line
ν1: Abbe number of the first lens
ν2: Abbe number of the second lens
ν3: Abbe number of the third lens
ν4: Abbe number of the parallel glass plate GF
TTL: optical length of the imaging lens LA

The aspheric shape of the surface of each of the first lens L1, the second lens L2, and the third lens L3 that constitute the imaging lens LA is expressed by the following aspheric polynomial, assuming that y is the optical axis when the direction of light travel is positive; and x is the axis that intersects the optical axis y:

y=(x²/R)/[1+{1−(k+1)(x/R)²}^{1/2}]+A4x⁴+A6x⁶+A8x⁸+A10x¹⁰ (4)

wherein R is the radius of curvature on the optical axis; k is a conic coefficient; and A4, A6, A8, and A10 are aspheric coefficients.

For the sake of convenience, the aspheric surface expressed by Polynomial (4) above is used as the aspheric surface of each lens surface. The aspheric surface, however, is not limited by Polynomial (4). Note that the symbols used for the imaging lenses according to Examples 1 to 4 below correspond to the symbols shown in FIG. 1.

### Example 1

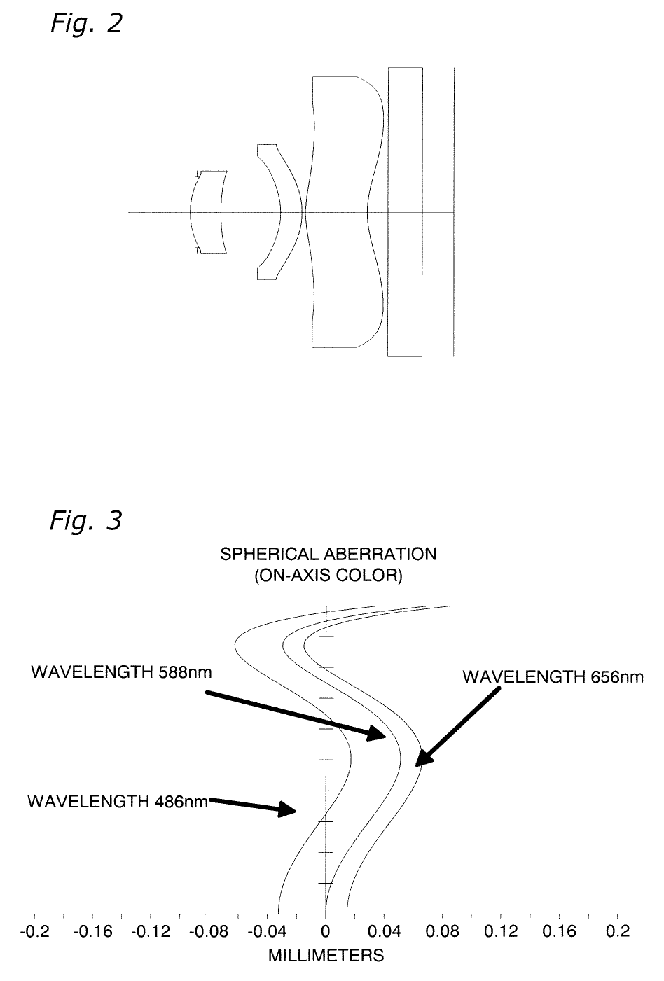

FIG. 2 shows the arrangement of the imaging lens LA of Example 1. Table 1 shows the radius of curvature R of the object-side surface or image-side surface for each of the first lens L1 to the third lens L3 that constitute the imaging lens LA of Example 1, the lens thickness, the distance d between lenses, the refractive index nd, and the Abbe number νd; and Table 2 shows the conic constant k and the aspheric coefficients.

TABLE 1

| | r | d | | nd | | νd | |
|---|---|---|---|---|---|---|---|
| S1 | ∞ | | −0.100 | | | | |
| R1 | 1.198 | d1 = | 0.440 | n1 = | 1.50914 | ν1 = | 56.2 |
| R2 | 3.017 | d2 = | 0.860 | | | | |
| R3 | −1.033 | d3 = | 0.310 | n2 = | 1.50914 | ν2 = | 56.2 |
| R4 | −1.177 | d4 = | 0.050 | | | | |
| R5 | 1.464 | d5 = | 0.890 | n3 = | 1.50914 | ν3 = | 56.2 |
| R6 | 1.425 | d6 = | 0.300 | | | | |
| R7 | ∞ | d7 = | 0.500 | n4 = | 1.5168 | ν4 = | 64.2 |
| R8 | ∞ | | | | | | |

TABLE 2

| | Conic Coefficient | Aspheric Coefficients | | | |
|---|---|---|---|---|---|
| | k | A4 | A6 | A8 | A10 |
| R1 | −6.879E−01 | −3.120E−02 | 5.904E−01 | 8.005E−02 | −2.405E+00 |
| R2 | 0.000E+00 | −9.666E−03 | 9.163E−01 | −2.654E+00 | 2.996E+00 |
| R3 | −4.962E+00 | 1.479E−02 | −4.215E−01 | 5.666E−01 | −4.978E−01 |
| R4 | −2.567E−01 | −1.032E−01 | 5.454E−01 | −5.910E−01 | 2.851E−01 |
| R5 | −1.804E+01 | −1.180E−01 | 9.068E−02 | −3.412E−02 | 4.657E−03 |
| R6 | −6.834E+00 | −5.433E−02 | 5.215E−03 | 2.427E−03 | −7.262E−04 |

Under these conditions, Conditional Expressions (1) to (3) are satisfied, as shown in Table 9, the optical length TTL is short, and the imaging lens LA is small.

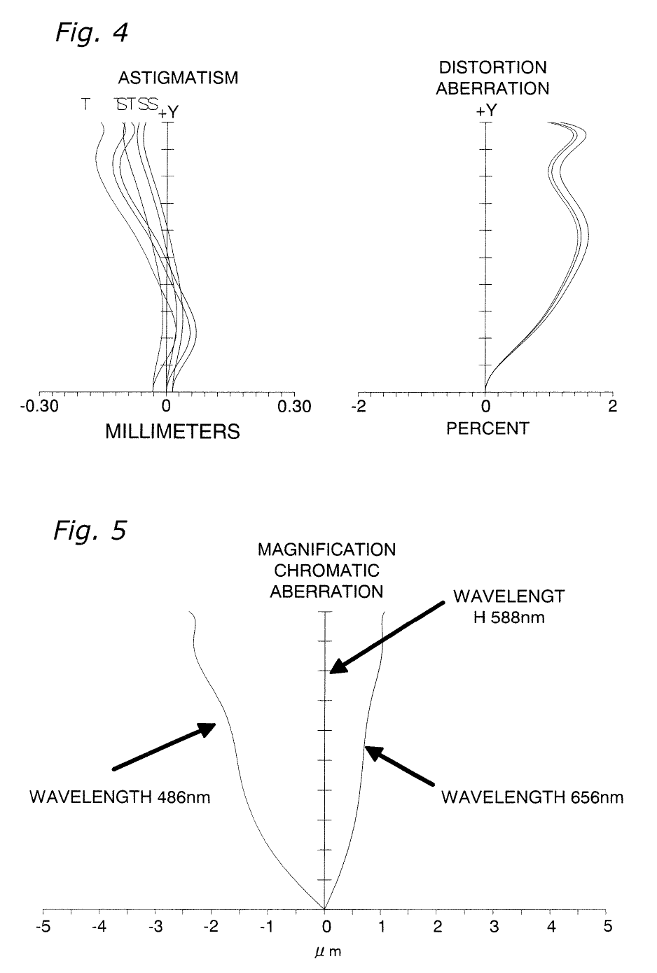

FIG. 3 shows the spherical aberration (on-axis chromatic aberration) of the imaging lens LA of Example 1; FIG. 4 shows the astigmatism and distortion aberration thereof; and FIG. 5 shows the magnification chromatic aberration thereof. These results reveal that the imaging lens LA of Example 1 is small and has good optical characteristics. Note that the aberrations shown in each diagram are the results measured at three wavelengths, i.e., 486 nm, 588 nm, and 656 nm. In the astigmatism diagram, the curves S represent the aberrations relative to the sagittal image plane, and the curves T represent the aberrations relative to the tangential image plane.

### Example 2

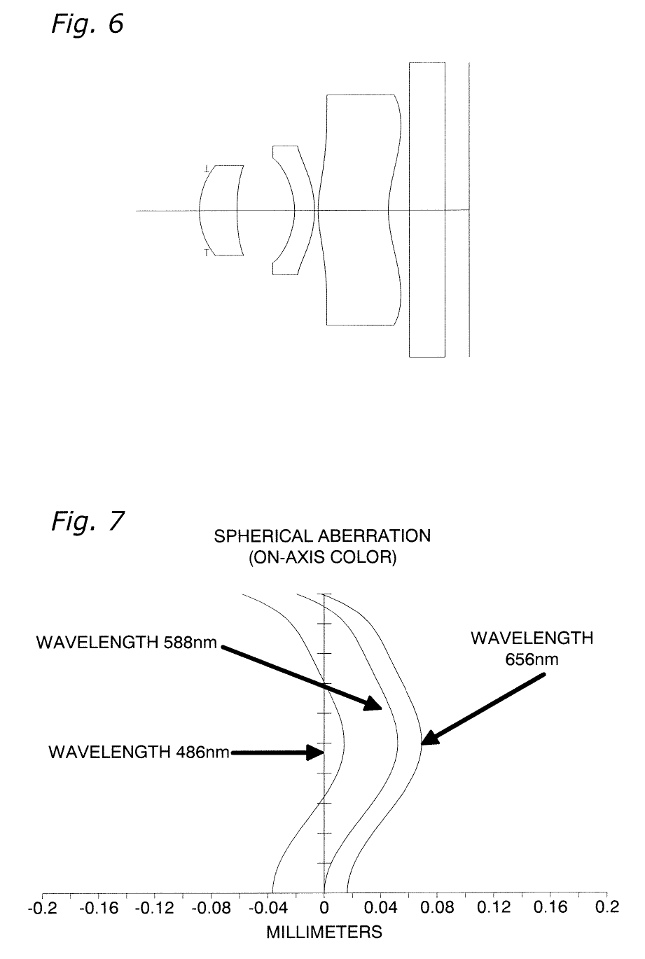

FIG. 6 shows the arrangement of the imaging lens LA of Example 2. Table 3 shows the radius of curvature R of the object-side surface or image-side surface for each of the first lens L1 to the third lens L3 that constitute the imaging lens LA of Example 2, the lens thickness, the distance d between lenses, the refractive index nd, and the Abbe number νd; and Table 4 shows the conic constant k and the aspheric coefficients.

TABLE 3

| | r | d | | nd | | νd | |
|---|---|---|---|---|---|---|---|
| S1 | ∞ | | −0.100 | | | | |
| R1 | 1.134 | d1 = | 0.530 | n1 = | 1.50914 | ν1 = | 56.2 |
| R2 | 3.388 | d2 = | 0.815 | | | | |
| R3 | −0.966 | d3 = | 0.280 | n2 = | 1.50914 | ν2 = | 56.2 |
| R4 | −1.515 | d4 = | 0.050 | | | | |
| R5 | 1.532 | d5 = | 1.000 | n3 = | 1.50914 | ν3 = | 56.2 |
| R6 | 1.722 | d6 = | 0.300 | | | | |
| R7 | ∞ | d7 = | 0.500 | n4 = | 1.5168 | ν4 = | 64.2 |
| R8 | ∞ | | | | | | |

TABLE 4

| | Conic Coefficient | Aspheric Coefficients | | | |
|---|---|---|---|---|---|
| | k | A4 | A6 | A8 | A10 |
| R1 | −5.441E−01 | −1.639E−02 | 5.834E−01 | −1.513E+00 | 1.759E+00 |
| R2 | 0.000E+00 | 4.746E−02 | 3.680E−01 | −1.234E+00 | 1.896E+00 |
| R3 | −4.770E+00 | −2.074E−03 | −4.513E−01 | 5.007E−01 | −6.473E−01 |
| R4 | −2.559E−01 | −9.604E−02 | 5.408E−01 | −6.011E−01 | 2.766E−01 |
| R5 | −1.929E+01 | −1.161E−01 | 9.130E−02 | −3.425E−02 | 4.634E−03 |
| R6 | −7.600E+00 | −5.775E−02 | 4.542E−03 | 2.337E−03 | −7.513E−04 |

Under these conditions, Conditional Expressions (1) to (3) are satisfied, as shown in Table 9, the optical length TTL is short, and the imaging lens LA is small.

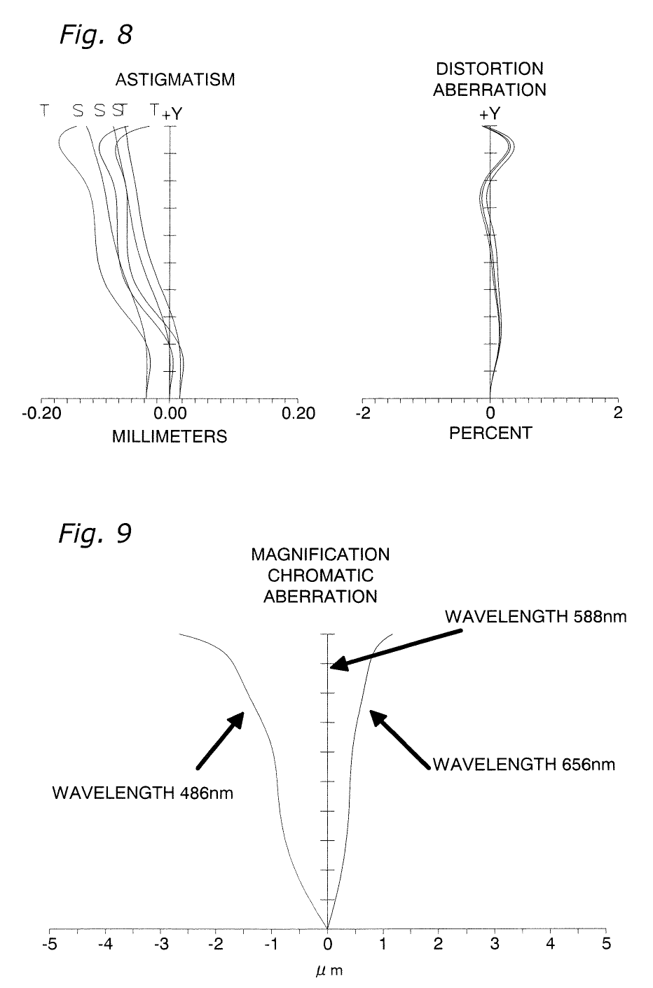

FIG. 7 shows the spherical aberration (on-axis chromatic aberration) of the imaging lens LA of Example 2; FIG. 8 shows the astigmatism and distortion aberration thereof; and FIG. 9 shows the magnification chromatic aberration thereof. These results reveal that the imaging lens LA of Example 2 is small and has good optical characteristics. Note that the aberrations shown in each diagram are the results measured at three wavelengths, i.e., 486 nm, 588 nm, and 656 nm. In the astigmatism diagram, the curves S represent the aberrations relative to the sagittal image plane, and the curves T represent the aberrations relative to the tangential image plane.

### Example 3

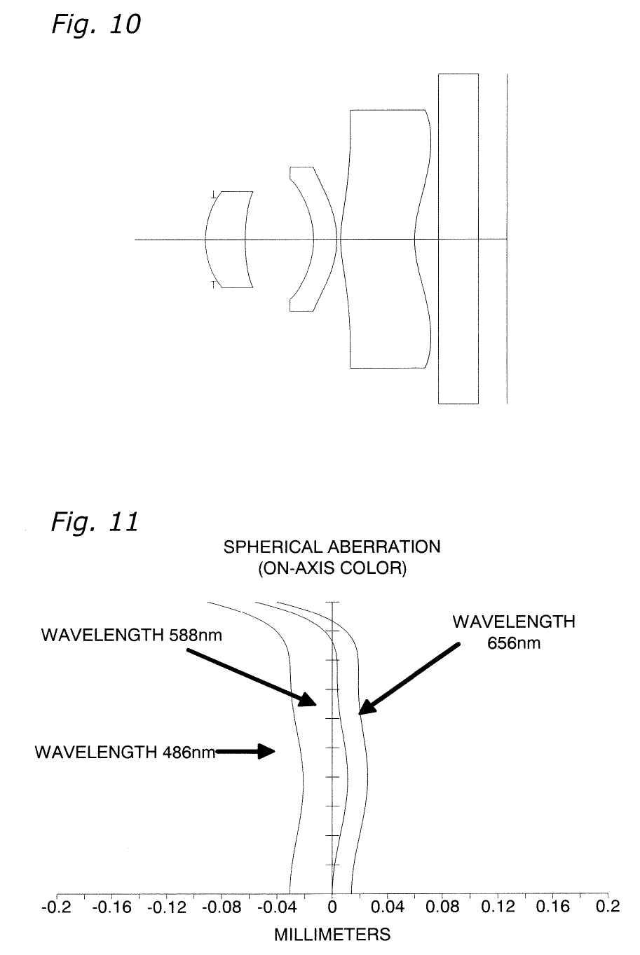

FIG. 10 shows the arrangement of the imaging lens LA of Example 3. Table 5 shows the radius of curvature R of the object-side surface or image-side surface for each of the first lens L1 to the third lens L3 that constitute the imaging lens LA of Example 3, the lens thickness, the distance d between lenses, the refractive index nd, and the Abbe number νd; and Table 6 shows the conic constant k and the aspheric coefficients.

TABLE 5

| | r | d | | nd | | νd | |
|---|---|---|---|---|---|---|---|
| S1 | ∞ | | −0.100 | | | | |
| R1 | 1.140 | d1 = | 0.500 | n1 = | 1.50914 | ν1 = | 56.2 |
| R2 | 3.020 | d2 = | 0.860 | | | | |
| R3 | −1.017 | d3 = | 0.290 | n2 = | 1.5850 | ν2 = | 30.0 |
| R4 | −1.286 | d4 = | 0.050 | | | | |
| R5 | 1.514 | d5 = | 0.940 | n3 = | 1.50914 | ν3 = | 56.2 |
| R6 | 1.457 | d6 = | 0.300 | | | | |
| R7 | ∞ | d7 = | 0.500 | n4 = | 1.5168 | ν4 = | 64.2 |
| R8 | ∞ | | | | | | |

TABLE 6

| | Conic Coefficient | Aspheric Coefficients | | | |
|---|---|---|---|---|---|
| | k | A4 | A6 | A8 | A10 |
| R1 | −2.949E−01 | 2.790E−02 | 4.058E−01 | −1.427E+00 | 2.215E+00 |
| R2 | 0.000E+00 | 4.667E−02 | 5.610E−01 | −1.699E+00 | 2.658E+00 |
| R3 | −4.246E+00 | 1.721E−02 | −3.603E−01 | 4.691E−01 | −5.392E−01 |
| R4 | −4.023E−01 | −7.483E−02 | 5.427E−01 | −6.038E−01 | 2.623E−01 |
| R5 | −2.256E+01 | −1.122E−01 | 9.084E−02 | −3.435E−02 | 4.620E−03 |
| R6 | −7.103E+00 | −5.912E−02 | 4.861E−03 | 2.627E−03 | −7.816E−04 |

Under these conditions, Conditional Expressions (1) to (3) are satisfied, as shown in Table 9, the optical length TTL is short, and the imaging lens LA is small.

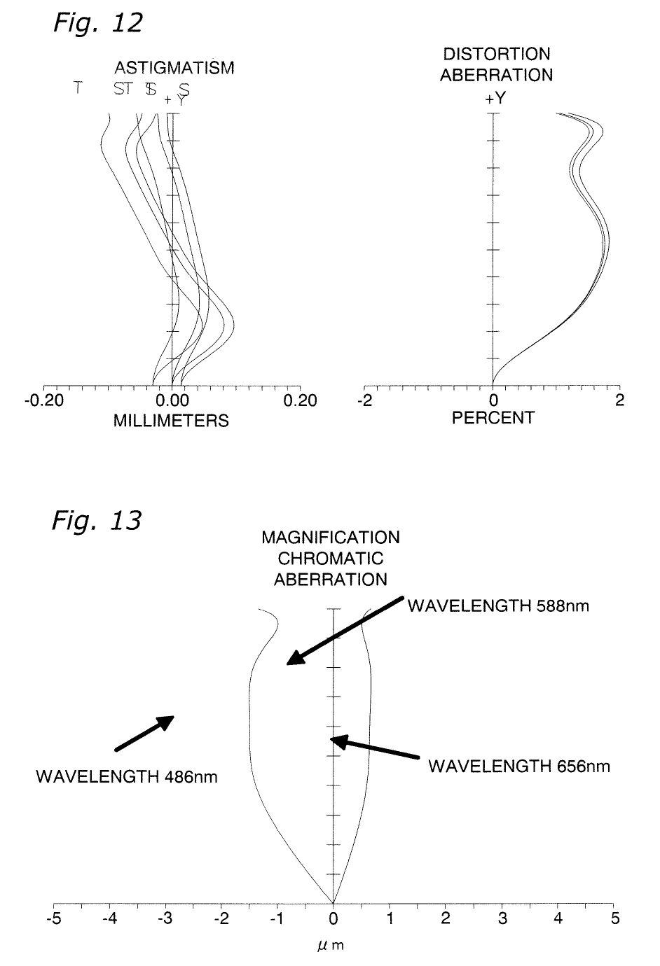

FIG. 11 shows the spherical aberration (on-axis chromatic aberration) of the imaging lens LA of Example 3; FIG. 12 shows the astigmatism and distortion aberration thereof; and FIG. 13 shows the magnification chromatic aberration thereof. These results reveal that the imaging lens LA of Example 3 is small and has good optical characteristics. Note that the aberrations shown in each diagram are the results measured at three wavelengths, i.e., 486 nm, 588 nm, and 656 nm. In the astigmatism diagram, the curves S represent the aberrations relative to the sagittal image plane, and the curves T represent the aberrations relative to the tangential image plane.

### Example 4

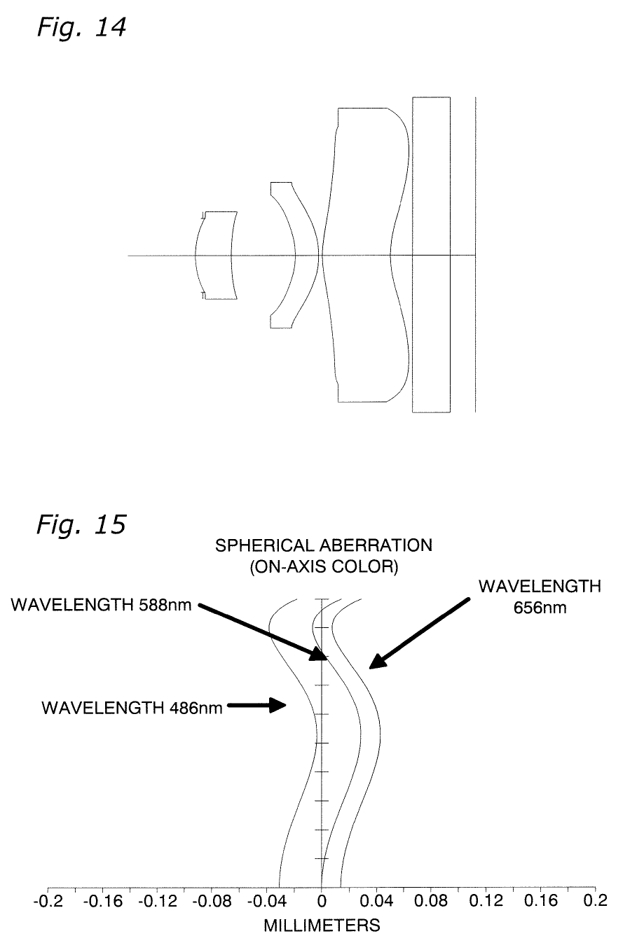

FIG. 14 shows the arrangement of the imaging lens LA of Example 4. Table 7 shows the radius of curvature R of the object-side surface or image-side surface for each of the first lens L1 to the third lens L3 that constitute the imaging lens LA of Example 4, the lens thickness, the distance d between lenses, the refractive index nd, and the Abbe number νd; and Table 8 shows the conic constant k and the aspheric coefficients.

TABLE 7

| | r | d | | nd | | νd | |
|---|---|---|---|---|---|---|---|
| S1 | ∞ | | −0.100 | | | | |
| R1 | 1.185 | d1 = | 0.470 | n1 = | 1.50914 | ν1 = | 56.2 |
| R2 | 3.115 | d2 = | 0.840 | | | | |
| R3 | −1.053 | d3 = | 0.310 | n2 = | 1.50914 | ν2 = | 56.2 |
| R4 | −1.165 | d4 = | 0.050 | | | | |
| R5 | 1.457 | d5 = | 0.895 | n3 = | 1.50914 | ν3 = | 56.2 |
| R6 | 1.311 | d6 = | 0.300 | | | | |
| R7 | ∞ | d7 = | 0.500 | n4 = | 1.5168 | ν4 = | 64.2 |
| R8 | ∞ | | | | | | |

TABLE 8

| | Conic Coefficient | Aspheric Coefficients | | | |
|---|---|---|---|---|---|
| | k | A4 | A6 | A8 | A10 |
| R1 | −6.879E−01 | 1.834E−02 | 4.195E−01 | −4.286E−01 | −4.767E−01 |
| R2 | 0.000E+00 | 2.802E−02 | 7.081E−01 | −2.423E+00 | 3.413E+00 |
| R3 | −4.962E−00 | 6.906E−03 | −4.319E−01 | 5.633E−01 | −4.653E−01 |
| R4 | −2.567E−01 | −1.003E−01 | 5.500E−01 | −5.848E−01 | 2.912E−01 |
| R5 | −1.804E+01 | −1.137E−01 | 9.277E−02 | −3.411E−02 | 4.603E−03 |
| R6 | −6.834E+00 | −5.316E−02 | 5.284E−03 | 2.463E−03 | −7.023E−04 |

Under these conditions, Conditional Expressions (1) to (3) are satisfied, as shown in Table 9, the optical length TTL is short, and the imaging lens LA is small.

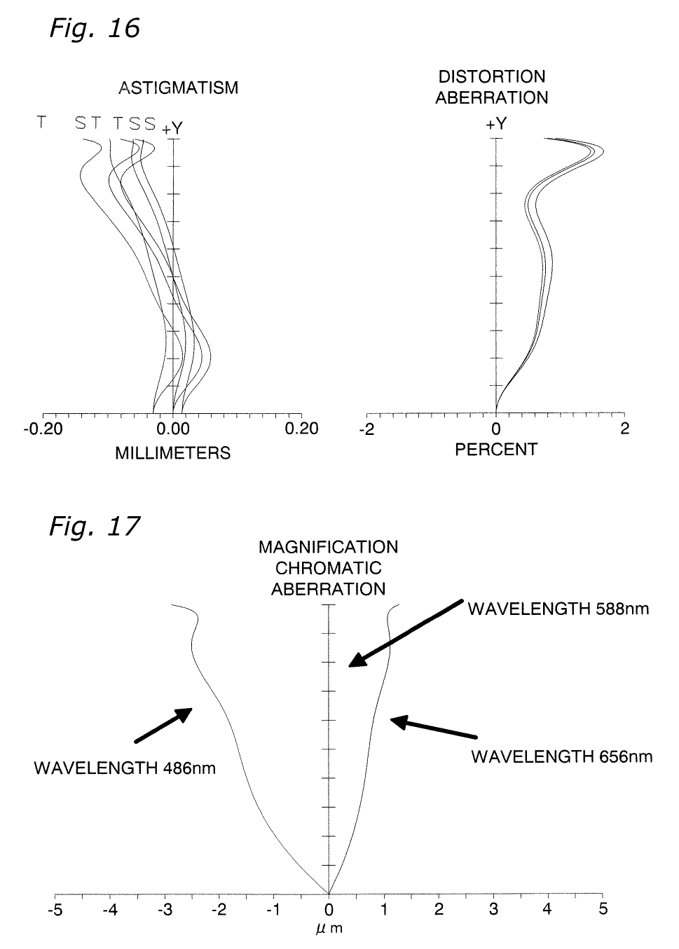

FIG. 15 shows the spherical aberration (on-axis chromatic aberration) of the imaging lens LA of Example 4; FIG. 16 shows the astigmatism and distortion aberration thereof; and FIG. 17 shows the magnification chromatic aberration thereof. These results reveal that the imaging lens LA of Example 4 is small and has good optical characteristics. Note that the aberrations shown in each diagram are the results measured at three wavelengths, i.e., 486 nm, 588 nm, and 656 nm. In the astigmatism diagram, the curves S represent the aberrations relative to the sagittal image plane, and the curves T represent the aberrations relative to the tangential image plane.

Table 9 shows various numerical values, as well as the values corresponding to the parameters defined in Conditional Expressions (1) to (3), for each Example. Note that the units of the various values shown in Table 9 are as follows: TTL (mm), f (mm), f1 (mm), f2 (mm), and f3 (mm).

TABLE 9

| | Ex. 1 | Ex. 2 | Ex. 3 | Ex. 4 | Note |
|---|---|---|---|---|---|
| f1/f | 1.202 | 0.960 | 1.060 | 1.200 | Conditional |
| | | | | | Expression (1) |
| f1/f2 | −0.060 | −0.490 | −0.240 | −0.011 | Conditional |
| | | | | | Expression (2) |
| d1/d2 | 0.512 | 0.650 | 0.581 | 0.560 | Conditional |
| | | | | | Expression (3) |
| Fno | 2.8 | 2.8 | 2.8 | 2.8 | |
| TTL | 3.800 | 3.820 | 3.799 | 3.698 | |
| f | 3.001 | 3.230 | 3.114 | 2.894 | |
| f1 | 3.608 | 3.102 | 3.301 | 3.473 | |
| f2 | −60.094 | −6.331 | −13.753 | −316.278 | |
| f3 | 15.736 | 9.839 | 16.625 | 26.964 | |

1. An imaging lens provided between an object and an image plane, comprising:
a diaphragm provided between the object and the image plane;
a first lens provided between the diaphragm and the image plane, the first lens having a positive power and a meniscus shape that is convex toward an object side;
a second lens provided between the first lens and the image plane, the second lens having a negative power and a meniscus shape that is convex toward an image side; and
a third lens provided between the second lens and the image plane, the third lens having a positive power and a meniscus shape that is convex toward the object side;
the imaging lens satisfying Conditional Expressions (1) to (3):
0.95<f1/f<1.50 (1);
−0.50<f1/f2<−0.00 (2); and
0.40<d1/d2<0.70 (3),
wherein:
f: a focal length of the entire lens system;
f1: a focal length of the first lens;
f2: a focal length of the second lens;
d1: a center thickness of the first lens; and
d2: a distance between an image-side surface of the first lens and an object-side surface of the second lens.
